(19) United States
(12) Patent Application Publication
(10) Pub. No.: US 2009/0164103 A1
(43) Pub. Date: Jun. 25, 2009

(54) FUEL INJECTION CONTROL DEVICE FOR ENGINE

(75) Inventors: Yusuke MATSUMOTO, Kawasaki-shi (JP); Shiroh SHIINO, Kawasaki-shi (JP); Kiyoharu YAMADA, Kawasaki-shi (JP); Keiichi OKUDE, Kawasaki-shi (JP)

Correspondence Address: ROSSI, KIMMS & McDOWELL LLP., 20609 Gordon Park Square, Suite 150, Ashburn, VA, 20147, US

(73) Assignee: MITSUBISHI FUSO TRUCK AND BUS CORPORATION, Kawasaki-shi (JP)

(21) Appl. No.: 12/342,130

(22) Filed: Dec. 23, 2008

(30) Foreign Application Priority Data
Dec. 25, 2007 (JP) 2007-332133

(51) Int. Cl. F02D 41/30

(52) U.S. Cl. 701/103

(57) ABSTRACT

A fuel injection control device for an engine comprises a fuel injecting device for directly injecting fuel into a cylinder of the engine and being capable of changing fuel injection rate arbitrarily during injecting the fuel, a fuel supplying device for supplying high-pressure fuel to the fuel injecting device, and a control unit for controlling the fuel injecting device depending on an operating region of the engine so as to adjust a quantity of fuel to be injected into the cylinder of the engine, the control means reducing the fuel injection rate of the fuel injecting device once and subsequently increasing the fuel injection rate during the main injection that contributes to torque generation of the engine.

### BACKGROUND OF THE INVENTION

1. Field of the Invention

The present invention relates to a fuel injection control device for an engine, specifically to a fuel injection control device by which fuel injection rate can be changed while fuel is injected into a cylinder.

2. Description of the Related Art

A diesel engine, for example, is operated forming a combustion mainly consisting of a diffusion combustion, i.e., where combustion is performed in a combustible gas mixture layer formed in a boundary of injected fuel and the surrounding compressed air. With this kind of engine, valve-opening duration and valve-opening start timing of a fuel injection valve are determined depending on an operation amount of an accelerator pedal, engine rotation speed and the like. The fuel injection valve is then controlled based on the valve-opening duration and the valve-opening start timing.

Such control of the fuel injection valve is carried out by a conventional fuel injection control device and such combustion within a cylinder is performed as shown for example in broken line in a timing chart of FIG. 2.

With this conventional manner, the fuel injection valve is first opened at a valve-opening start timing, and then a lift amount of a needle valve of the fuel injection valve is increased. As the lift amount is increased, rate of fuel injection into the cylinder is increased rapidly until it reaches the maximum value. Rate of heat generation due to combustion of the fuel injected into the cylinder rapidly increases with the rise of the fuel injection rate as shown in the drawing, and then hits the peak and gradually decreases. Here, combustion pressure generated due to the fuel combustion within the cylinder is converted via a piston and a crank shaft into engine torque. Then, the lift amount of the needle valve is reduced toward valve-closing timing, and finally the fuel injection valve is closed. As the amount of the lift decreases, the fuel injection rate is reduced to 0 and heat generation rate within the cylinder decreases, too.

This kind of diffusion combustion tends to be influenced by various factors such as injection pressure of the fuel, shape of a combustion chamber, air flow in the cylinder and the like. If any of the factors becomes slightly improper, a fuel-rich area is formed due to unfavorable mixture of the fuel and the air in the combustible gas mixture layer. As fuel existing in excess cannot be burned normally in such fuel-rich area because of the lack of the air, increase in smoke generation in the cylinder, and consequently increase in exhaust smoke from the cylinder are caused. Additionally, as can be assumed from that increase in heat generation rate hits the peak, as shown in broken line in FIG. 2, combustion state is deteriorated due to incomplete combustion of the injected fuel, so that a problem of a poor gas mileage may be caused.

Various technical approaches for improving the combustion state within the cylinder of an engine have been proposed. For example, one of the technical approaches is disclosed in Japanese Unexamined Patent Publication No. 2003-148220 (hereinafter referred to as Patent Document 1). In the technique disclosed in Patent Document 1, lift amount of the fuel injection valve is controlled so that rapid increase in fuel injection rate is suppressed in the initial stage of the injection duration, and then the fuel injection rate is increased to its maximum.

The suppression of the rapid increase in fuel injection rate at the initial stage of the injection as disclosed in Patent Document 1 is aimed at preventing fuel injected into the cylinder from being burned rapidly. In other words, the technique disclosed in Patent Document 1 has effect in suppressing combustion noise and in reducing generation amount of NOx within the cylinder by preventing the fuel from being burned rapidly. The technique disclosed in Patent Document 1, however, is not aimed at avoiding formation of a fuel-rich area within the cylinder. Thus, the technique disclosed in Patent Document 1 cannot solve the aforementioned problem, and therefore an effective measure for solving the aforementioned problem has been desired.

### SUMMARY OF THE INVENTION

An aspect of the present invention is directed to a fuel injection control device for an engine, comprising: fuel injecting means for directly injecting fuel into a cylinder of an engine, fuel injection rate of the fuel injecting means being able to be changed arbitrarily during injecting the fuel; fuel supplying means for supplying high-pressure fuel to the fuel injecting means; and control means for controlling the fuel injecting means depending on an operating region of the engine so as to adjust a quantity of fuel to be injected into the cylinder of the engine, the control means reducing the fuel injection rate of the fuel injecting means once and subsequently increasing the fuel injection rate during the main injection that contributes to torque generation of the engine.

### BRIEF DESCRIPTION OF THE DRAWINGS

The present invention will become more fully understood from the detailed description given hereinafter and the accompanying drawings which are given by way of illustration only, and thus, are not limitative of the present invention, and wherein:

FIG. 1 is a view showing the entire configuration of a fuel injection control device for an engine according to one embodiment of the present invention; and

FIG. 2 is a timing chart showing a state of a fuel injection valve controlled by an ECU and a combustion state within a cylinder.

### DETAILED DESCRIPTION OF THE INVENTION

A fuel injection control device for an engine according to one embodiment of the present invention will now be described below in detail with reference to attached drawings.

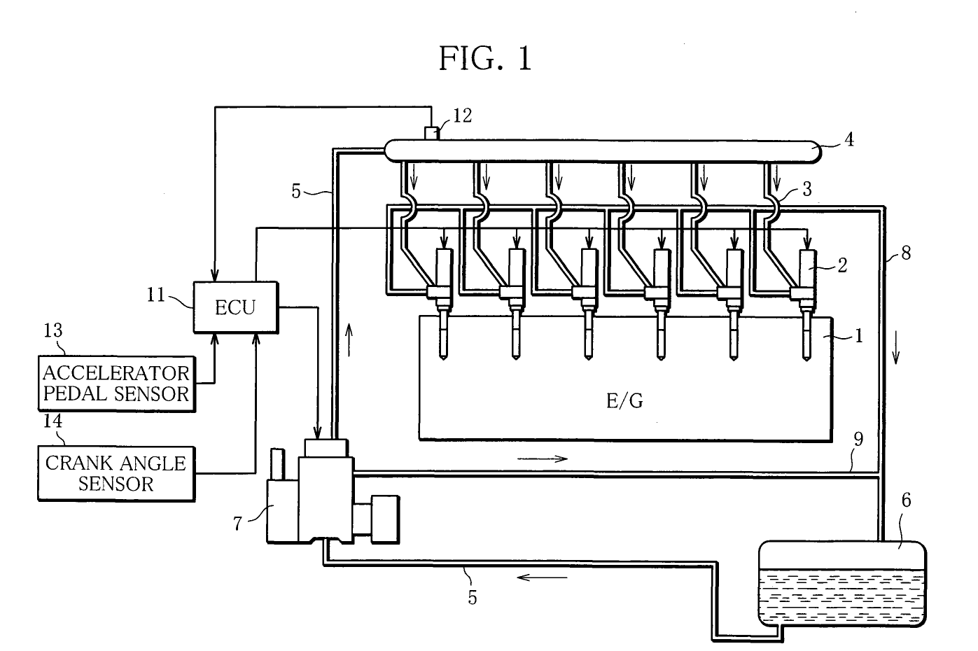

FIG. 1 is a view showing an entire configuration of the fuel injection control device for an engine according to the embodiment. In the present embodiment, an engine 1 is configured as in-line six-cylinder diesel engine that is installed in a vehicle. Each cylinder of the engine 1 is provided with a fuel injection valve (fuel injection means) 2.

Each fuel injection valve 2 is connected via fuel delivery pipe 3 to a common rail (fuel supplying means) 4. The common rail 4 is connected via a fuel force-feed pipe 5 to a fuel tank 6 of the vehicle. A supply pump 7 configured by a positive displacement plunger pump is interposed midway of the fuel force-feed pipe 5. As is well known, the supply pump 7 is driven by the engine 1 in synchronization with the rotation of the engine 1 and pressurizes fuel from the fuel tank 6 so as to discharge it to the common rail 4.

The fuel tank 6 is connected via a return pipe 8 to each fuel injection valve 2, and via a return pipe 9 to the supply pump 7. The surplus fuel produced by opening and closing of the fuel injection valve 2 and by the discharge pressure control of the supply pump 7 is collected via the return pipes 8 and 9 to the fuel tank 6.

Fuel stored in the common rail 4 is continuously supplied to the fuel injection valves 2 of each cylinder, and injected to the corresponding cylinder depending on the opening and closing of a needle valve incorporated in each fuel injection valve 2. The fuel injection valve 2 of the present embodiment is configured so as to arbitrarily vary the lift amount of the needle valve from 0 to its maximum, so that the fuel injection rate into the cylinder can be varied during the fuel injection.

In the vehicle interior, an ECU (control means) 11 equipped with input/output devices (not shown), memory devices such as ROM, RAM, BURAM and the like for storing control programs, control maps and the like, a central processing unit (CPU), and timer counters and the like is provided so as to conduct a fuel injection control of the engine 1.

To the input side of the ECU 11 various sensors such as a pressure sensor 12, accelerator pedal sensor 13, crank angle sensor 14 and the like, and various switches are connected. The pressure sensor 12 detects fuel pressure P in the common rail 4. The accelerator pedal sensor 13 detects operation amount ACC of an accelerator pedal by a driver. The crank angle sensor 14 outputs the crank angle pulse depending on the crank angle of the engine 1. To the output side of the ECU 11 various devices such as each fuel injection valve 2, the supply pump 7 and the like are connected.

The ECU 11 controls rail pressure of the common rail 4, injection duration and injection timing of each fuel injection valve 2 based on the detection information from these sensors. Fuel injection amount into the engine 1, which is a common rail type diesel engine, is determined unambiguously depending on the actual rail pressure of the common rail 4 and the valve-opening duration of the fuel injection valve 2. Accordingly, the optimum fuel injection amount can be achieved by controlling the actual rail pressure and the valve-opening duration.

The actual rail pressure can be controlled depending on the open/close condition of an electromagnetic valve (not shown) incorporated in the supply pump 7. The ECU 11 determines target rail pressure in accordance with a map (not shown) on the basis of engine rotation speed Ne evaluated from the crank angle pulse output from the crank angle sensor 14 and fuel injection amount in the preceding combustion cycle. By controlling the opening/closing of the electromagnetic valve based on the target rail pressure, the ECU 11 keeps the actual rail pressure equal to the target rail pressure.

The ECU 11 also determines fuel injection amount from the fuel injection valve 2 (in other words, valve-opening duration of the fuel injection valve 2) depending on the engine rotation speed Ne and the operation amount ACC of the accelerator pedal in accordance with a map (not shown). The ECU 11 further determines fuel injection start timing (in other words, valve-opening start timing of the fuel injection valve 2) depending on the fuel injection amount and the engine rotation speed Ne in accordance with a map (not shown). ECU 11 operates the engine 1 by controlling the fuel injection valve 2 on the basis of the fuel injection amount and the injection starting timing.

In addition, in the present embodiment, the ECU 11 variably controls the fuel injection rate of the fuel injection valve 2 during fuel injection in order to suppress an increase in discharged amount of smoke and a deterioration of gas mileage caused by fuel-rich area being formed in the cylinder. This fuel injection control will be described in detail below.

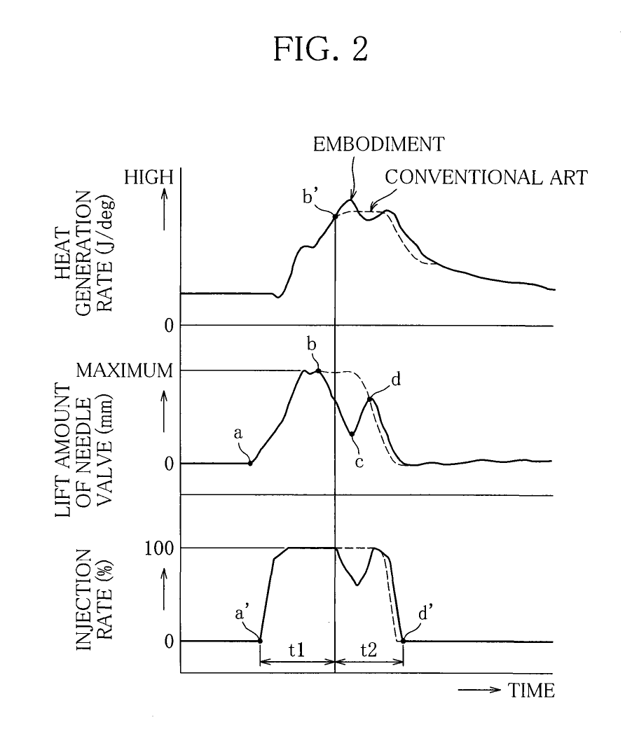

FIG. 2 is a timing chart showing a state of a fuel injection valve 2 controlled by the ECU 11 and a combustion state within a cylinder. The states in the present embodiment are shown in solid line in this drawing, while the states in a conventional manner, where the fuel injection rate is maintained to be constant, is shown in broken line. Fuel injection shown in the drawing corresponds to main injection that contributes to engine torque. Though not shown in the drawing, pilot injection and post injection are appropriately performed before and after the main injection respectively, depending on an operating region of the engine 1.

The ECU 11 evaluates crank angle of the engine 1 in accordance with a crank pulse from the crank angle sensor 14. When the ECU 11 decides depending on the evaluated crank angle that valve-opening start timing arrives with respect to one of the cylinders at a time “a” in FIG. 2, the ECU 11 starts increasing the lift amount of the needle valve incorporated in the fuel injection valve 2 of the corresponding cylinder from 0. At this time, the ECU 11 may control the needle valve so that the lift amount varies at the maximum rate. Alternatively, the ECU 11 may control the needle valve so that the lift amount varies at a predetermined varying rate. Following the increase in the lift amount of the needle valve, rate of the fuel injection into the cylinder increases rapidly until it reaches the maximum value. By the fuel injected into the cylinder being burned, the heat generation rate in the cylinder gradually increases.

If the fuel injection rate during the fuel injection is kept at a constant value as in a conventional manner, the increase in heat generation rate may hit the peak as shown in broken line at a time “b′” in the drawing although the fuel injection rate is kept at its maximum. This phenomenon is caused by the reason stated in the “BACKGROUND OF THE INVENTION”. In other words, a fuel-rich area is formed due to unfavorable mixture of the fuel and the air in the combustible gas mixture layer during diffusion combustion, and fuel existing in excess in the fuel-rich area is not burned completely because of the lack of the air, so that combustion state is deteriorated to cause the phenomenon. Such formation of the fuel-rich area may also lead to increase in smoke generation in the cylinder.

In the present embodiment, the ECU 11 starts reducing the lift amount of the needle valve incorporated in the fuel injection valve 2 at a time “b” preceding the time “b′”. Following the reduced lift amount, the fuel injection rate, which has already achieved at its maximum value, starts reducing. After the ECU 11 continues to reduce the lift amount until a time “c”, and then at the time “c”, the ECU 11 starts increasing the lift amount again. As the time “c” is set prior to a time before the time when the lift amount is reduced to 0, the fuel injection rate is not reduced to 0 and it turns to increase at a certain value. Subsequently, when the ECU 11 decides at a time “d” that valve-opening duration of the fuel injection valve 2 ends, the ECU 11 reduces the lift amount of the needle valve to 0 as shown in the drawing.

During the process of reducing the lift amount from the time “b” to the time “c”, during the process of increasing the lift amount from the time “c” to the time “d”, and during the process of increasing the lift amount after the time “d”, the ECU 11 may control the needle valve so as that the lift amount varies at the maximum rate. Alternatively, the ECU 11 may control the lift amount of the needle valve on the basis of a predetermined varying rate.

As mentioned above, the time “b′” is a time when the heat generation rate within the cylinder hits the peak because a fuel-rich area is formed due to unfavorable mixture of the fuel and the air in the combustible gas mixture layer. In other words, the time “b′” is a time when increase in the heat generation rate does not follow increase in the fuel injection rate any more. The time “b” is set preceding to the time “b′” by a time period corresponding to a response delay of the fuel injection rate with respect to the change of the lift amount of the needle valve which is caused by a factor such as inertia of the fuel. By starting reducing the lift amount of the needle valve at such time “b”, the fuel injection rate starts being lowered at the optimum timing substantially coinciding with the time “b′” when the fuel-rich area starts being formed.

As the amount of fuel being fed into the cylinder is reduced transiently with the fuel injection rate being reduced, combustion of the excessive fuel in the fuel-rich area is promoted, so that the fuel-rich area gradually shrinks. Consequently, generation of smoke in the cylinder due to this fuel-rich area is suppressed. At the same time, as the fuel and the air is mixed at a ratio approximating the theoretical equivalence ratio, the combustion temperature is raised, so that burning of the smoke that has been generated in the fuel-rich area within the cylinder is promoted, too. Due to these two factors, the smoke emission from the cylinder can be reduced considerably. As the rise of the combustion temperature leads to increase in the heat generation rate as shown in FIG. 2 after the time “b′”, the combustion state in the cylinder is improved, resulting in that the gas mileage is improved at a large extent.

The heat generation rate hits the peak due to the formation of the fuel-rich area at a point of time quite long after the start of the fuel injection. Therefore, the time “b′” when the fuel injection rate begins to be reduced is inevitably set in the latter half of an area with the fuel injection rate being higher than 0% (i.e. main injection period). In other words, the time “b′” is set so as to fulfill relation t1>t2, wherein t1 is the time period from the time “a′”, at which the fuel injection rate starts to be increased from 0%, to the time “b′”, and t2 is the time period from the time “b′” to the time “d′”, at which the fuel injection rate is decreased to be 0%.

In the present embodiment, after the lift amount of the needle valve is reduced from the time “b” to the time “c”, the lift amount is increased from the time “c” to the time “d”. If the lift amount of the needle valve is kept at a constant value after its reduction and thereby the valve-opening duration of the fuel injection valve 2 is prolonged, expected engine torque can be achieved indeed. In this case, however, as combustion state with low heat generation rate continues for a long time due to the lack of the fuel, the combustion state is not preferable. Therefore, in the present embodiment, the lift amount of the needle valve is increased again at a point of time when the fuel forming the fuel-rich area is completely burned, or a slightly earlier. By this measure, the fuel injection rate, which is once reduced, is increased again, so that a favorable combustion state can be kept.

The time “c” when the lift amount of the needle valve turns upward from downward is set, considering such combustion state within the cylinder, so that the fuel injection rate is reduced to a preferable value for shrinking the fuel-rich area estimating the response delay of the fuel injection rate with respect to the change of the lift amount. If the time “c” is set to be too early, for example, the fuel-rich area cannot be reduced sufficiently. If the time “c” is set to be too late, on the other hand, lack of fuel is caused due to suppressed fuel injection rate, so that combustion state is deteriorated. Therefore, the time “c” is set so as to avoid these phenomena.

The optimum time “b” when the lift amount of the needle valve starts being reduced and the optimum time “c” when the lift amount of the needle valve starts being increased again vary depending on the operating region of the engine 1. Therefore, in an actual fuel injection control, maps for setting the optimum time “b” and the time “c” depending on the engine rotation speed Ne, the fuel injection amount and the like are prepared in advance. The ECU 11 controls the lift amount of the needle valve on the basis of the time “b” and the time “c” obtained from the maps.

Naturally, the time “b” and the time “c” are not set in the maps for an operating region where the fuel-rich area is not formed for sure. In such an operating region, the fuel injection rate is kept at a substantially constant value during the fuel injection as in the case of usual conventional fuel injection control.

It must be noted that this transient reduction of the fuel injection rate may lead, in spite of the aforementioned various effects, to increase in generation of NOx due to increase of combustion temperature. But the effect of the increase in generated amount of NOx by this control is very small compared to the effect of reducing smoke emission, and the increase in generation of NOx can be handled sufficiently by setting the optimum injection timing, for example. Therefore, a fuel injection control device according to the present embodiment can considerably improve the characteristic on exhaust gas of the engine 1 as a whole.

As mentioned above, the fuel injection device for an engine according to the present embodiment controls the lift amount of the needle valve so that the fuel injection rate of the fuel injection valve 2, which is once reduced, is increased again in the main injection. As a result, the fuel being fed into the cylinder is reduced transiently, so that formation of the fuel-rich area at diffusion combustion can be suppressed considerably. Consequently, smoke emission from the cylinder can be considerably reduced, and at the same time combustion state can be improved, resulting in that the gas mileage can be improved at a large extent.

Furthermore, the point of time when the fuel injection rate begins to be reduced is set to the time “b′” at which increase in heat generation rate does not follow the increase of the fuel injection rate any more. (It is inevitably set in the latter half of an area with the fuel injection rate being higher than 0%) Thus, it is possible to start reducing the fuel injection rate at the optimum timing when the fuel-rich area begins to be formed. As a result, the formation of the fuel-rich area can be surely suppressed.

Although the description of the present embodiment is herewith completed, the present invention is not limited to this embodiment. For example, control of the lift amount of the needle valve can be varied in various ways from the aforementioned embodiment. In a operating region where a massive fuel-rich area may be formed, for example, the ECU 11 may control the lift amount of the needle valve to be reduced once to 0 so as that fuel feed into the cylinder can be suspended completely and the fuel injection rate is reduced to 0%. The ECU 11 may also keep the reduced lift amount of the needle valve to a constant level for a predetermined time period from the time “c” and then make it increase. Furthermore, the ECU 11 may keep the fuel injection rate, which is reduced once, at a constant value by suspending the increase halfway, instead of increasing the fuel injection rate to the maximum value again.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A fuel injection control device for an engine, comprising:
fuel injecting means for directly injecting fuel into a cylinder of an engine, fuel injection rate of the fuel injecting means being able to be changed arbitrarily during injecting the fuel;
fuel supplying means for supplying high-pressure fuel to the fuel injecting means; and
control means for controlling the fuel injecting means depending on an operating region of the engine so as to adjust a quantity of fuel to be injected into the cylinder of the engine, the control means reducing the fuel injection rate of the fuel injecting means once and subsequently increasing the fuel injection rate during the main injection that contributes to torque generation of the engine.

2. The fuel injection control device for an engine according to claim 1, wherein
the fuel injecting means injects the fuel into the cylinder of the engine by opening and closing a needle valve, and the fuel injection rate is changed by varying a lift amount of the needle valve.

3. The fuel injection control device for an engine according to claim 1, wherein
the control means starts reducing the fuel injection rate at a point of time when heat generation rate due to combustion of the injected fuel in said cylinder does not increase any more following the increase in the fuel injection rate after starting the main injection.

4. The fuel injection control device for an engine according to claim 3, wherein
the control means starts reducing the fuel injection rate in the latter half of duration of the main injection.

5. The fuel injection control device for an engine according to claim 3, wherein
the control means starts increasing the fuel injection rate at a point of time when a fuel-rich area in a combustible gas mixture layer which is formed within the cylinder due to the main injection shrinks because of the fuel injection rate being reduced and when the combustion is not yet deteriorated due to lack of fuel caused by the reduction of the fuel injection rate.

6. The fuel injection control device for an engine according to claim 1, wherein
the control means starts increasing the fuel injection rate at a point of time when a fuel-rich area in a combustible gas mixture layer which is formed within the cylinder due to the main injection shrinks because of the fuel injection rate being reduced and when the combustion is not yet deteriorated due to lack of fuel caused by the reduction of the fuel injection rate.
